(19) United States
(12) Patent Application Publication
(10) Pub. No.: US 2025/0094674 A1
(43) Pub. Date: Mar. 20, 2025

(54) MODEL COMPENSATIONS

(71) Applicant: HEWLETT-PACKARD DEVELOPMENT COMPANY, LP., Spring, TX (US)

(72) Inventors: Juheon LEE, Palo Alto, CA (US); Juan Carlos CATANA SALAZAR, Guadalajara, JAL (MX); Nathan MORONEY, Palo Alto, CA (US); Jun ZENG, Palo Alto, CA (US)

(73) Assignee: HEWLETT-PACKARD DEVELOPMENT COMPANY, LP., Spring, TX (US)

(21) Appl. No.: 18/293,281

(22) PCT Filed: Jul. 30, 2021
(86) PCT No.: PCT/US2021/043865

§ 371 Date: Jan. 29, 2024

(51) Int. Cl. G06F 30/27

(52) U.S. Cl. CPC G06F 30/27

(57) ABSTRACT

Examples of methods are described herein. In some examples, a method includes generating, using a compensation machine learning model after training, a compensated model based on a three-dimensional (3D) object model. In some examples, the compensation machine learning model is trained by generating candidate compensation plans and evaluating, using a deformation machine learning model, the candidate compensation plans. In some examples, the method includes adjusting the 3D object model based on the compensated model to produce an adjusted model.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for model compensation;

FIG. 2 is a block diagram illustrating an example of an architecture that may be utilized in accordance with some examples of the techniques described herein;

FIG. 3 is a block diagram of an example of an apparatus that may be used in model compensation;

FIG. 4 is a block diagram illustrating an example of a computer-readable medium for model compensation;

FIG. 5 is a block diagram illustrating an example of a machine learning model architecture;

FIG. 6A is a diagram illustrating an example of an object model point cloud;

FIG. 6B is a diagram illustrating an example of a scanned object point cloud;

FIG. 7 is a block diagram illustrating an example of an architecture that may be utilized to train a deformation machine learning model in accordance with some examples of the techniques described herein; and

FIG. 8 is a block diagram illustrating an example of an architecture that may be utilized to train a compensation machine learning model in accordance with some examples of the techniques described herein.

### DETAILED DESCRIPTION

Additive manufacturing may be used to manufacture three-dimensional (3D) objects. In some examples, additive manufacturing may be achieved with 3D printing. For example, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size.

In some examples, the techniques described herein may be utilized for various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi-Jet Fusion (MJF), Metal Jet Fusion, metal binding printing, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object. For example, agents (e.g., fusing agent, detailing agent, etc.) may be selectively deposited to control voxel-level energy deposition, which may trigger a phase change and/or solidification for selected voxels. The manufactured object geometry may be driven by the fusion process, which enables predicting or inferencing the geometry following manufacturing. Some first principle-based manufacturing simulation approaches are relatively slow, complicated, and/or may not provide target resolution (e.g., sub-millimeter resolution). Some machine learning approaches (e.g., some deep learning approaches) may offer increased resolution and/or speed. As used herein, the term “predict” and variations thereof may refer to determining and/or inferencing. For instance, an event or state may be “predicted” before, during, and/or after the event or state has occurred.

A machine learning model is a structure that learns based on training. Examples of machine learning models may include artificial neural networks (e.g., deep neural networks, convolutional neural networks (CNNs), graph neural networks (GNNs), etc.). Training the machine learning model may include adjusting a weight or weights of the machine learning model. For example, a neural network may include a set of nodes, layers, and/or connections between nodes. The nodes, layers, and/or connections may have associated weights. The weights may be adjusted to train the neural network to perform a function, such as predicting object geometry after manufacturing, object deformation, or compensation. Examples of the weights may be in a relatively large range of numbers and may be negative or positive.

An object model is data that represents an object. For example, an object model may include geometry (e.g., points, vertices, lines, polygons, etc.) that represents an object.

Some examples of the techniques described herein may utilize a machine learning model (e.g., deep neural network) to predict or infer a deformed model. A deformed model is an object model that indicates object deformation (e.g., deformation from manufacturing). For example, a machine learning model may provide a quantitative model for predicting object deformation. Object deformation is a change or disparity in object geometry from a 3D object model. A 3D object model is a 3D geometrical model of an object. Examples of 3D object models include computer-aided design (CAD) models, mesh models, 3D surfaces, etc. In some examples, a 3D object model may be utilized to manufacture (e.g., print) an object. In some examples, an apparatus may receive a 3D object model from another device (e.g., linked device, networked device, removable storage, etc.) or may generate the 3D object model. Object deformation may occur during manufacturing due to thermal diffusion, thermal change, gravity, manufacturing errors, etc. In some examples, the deformed model may be expressed as a point cloud, mesh model, isometric mesh, 3D object model (e.g., CAD model), etc. In some examples, a machine learning model may predict the deformed model based on a 3D object model (e.g., a compensated model).

Some examples of the techniques described herein may utilize a machine learning model (e.g., a deep neural network) to predict or infer a compensated model. A compensated model is an object model that is compensated for potential or anticipated deformation (e.g., deformation from manufacturing). For example, a machine learning model may provide a quantitative model for predicting object compensation (e.g., a compensated object model, compensated object model point cloud, compensated isometric mesh, etc.). The compensated model may be expressed as a point cloud, mesh model, isometric mesh, 3D object model (e.g., computer-aided design (CAD) model), etc. In some examples, a machine learning model may predict or infer the compensated model. For instance, a machine learning model may predict the compensated model based on target geometry (e.g., a 3D object model). In some examples, manufacturing (e.g., printing) an object according to the compensated model may reduce error or geometric inaccuracy in the manufactured object, which may provide more accurate manufacturing.

Some examples of the techniques described herein may utilize architectures of machine learning models (e.g., deep neural networks) to predict and/or compensate for geometric deformation of a 3D object or objects for a printing procedure. Some examples of the machine learning models (e.g., deep neural networks) may operate on isometric meshes and/or 3D point clouds. In some examples, a 3D isometric mesh and/or point cloud may be generated from another geometric representation (e.g., computer-aided design (CAD), mesh, voxels, etc.). A 3D isometric mesh and/or point cloud may be utilized to predict deformation of 3D objects and to compensate for the deformation to increasing printing quality.

Some examples of the techniques described herein may include a data-driven end-to-end machine learning architecture that predicts and compensates for geometric deformation of 3D objects for a printing procedure. In some examples, during training procedures, a deformation machine learning model may guide a compensation machine learning model. For instance, the deformation machine learning model and compensation machine learning model may be trained in an adversarial or serial manner. Training strategy may vary based on data types and/or size. Some examples of the techniques described herein may provide a machine learning architecture that is scalable to handle complicated geometric deformation including geometric warpage. For instance, some examples of the machine learning architecture may compensate for large object geometric warpage.

In some examples of the techniques described herein, point clouds may be utilized to represent 3D objects and/or 3D object geometry. A point cloud is a set of points or locations in a 3D space. A point cloud may be utilized to represent a 3D object or 3D object model. For example, a 3D object may be scanned with a 3D scanner (e.g., depth sensor(s), camera(s), light detection and ranging (LIDAR) sensors, etc.) to produce a scanned object point cloud representing the 3D object (e.g., manufactured object, 3D printed object, etc.). The scanned object point cloud may include a set of points representing locations on the surface of the 3D object in 3D space. In some examples, an object model point cloud may be generated from a 3D object model (e.g., CAD model). For example, a selection of the points from a 3D object model may be performed. For instance, an object model point cloud may be generated from a sampling of points from a surface of a 3D object model in some approaches.

In some examples of the techniques described herein, an isometric mesh may be utilized to represent a 3D object(s) and/or 3D object geometry. An isometric mesh is a set of points or locations in a 3D space that form shapes (e.g., faces, polygons, triangles, trapezoids, etc.) with a parameter or parameters (e.g., edge length(s), area, and/or angle(s), etc.) that are within a range from each other (e.g., that are equal or approximately equal). For instance, an isometric mesh may represent a 3D object or 3D object model with triangles that have similar area, edge length(s), and/or internal angle(s) (e.g., within ±2%, 5%, 10%, ±15%, 0.2 millimeters (mm), ±0.3 mm, 1 mm, ±30°, ±40°, ±60°, and/or another amount). In some examples, a 3D object model may be converted to an isometric mesh by sampling points from the 3D object model that are at an approximately equal distance d (e.g., within ±2%, ±5%, ±10%, ±15%, ±0.2 mm, ±0.3 mm, ±1 mm, and/or another amount) between points. The isometric mesh may be parameterized by d. For instance, triangle lengths and angles may be approximately equal because sampled points may preserve an approximately constant distance d between the points. In some examples, an isometric mesh may include triangles that are approximately equilateral and/or that have internal angles approximately equal to 60°.

In some examples, a CAD model may be converted into an isometric mesh. Geometric primitives (e.g., triangles, rectangle, hexagonal meshes, etc.) of a CAD model may not be uniformly shaped. For instance, the geometric primitives of a CAD model may vary with respect to geometry. Irregular geometric primitives may impact the operation of a machine learning model (e.g., GNN). For instance, irregular geometric primitives may reduce prediction accuracy of a machine learning model. To reduce the effect of irregular geometric primitives, a CAD model may be converted to an isometric mesh. In some examples, an isometric mesh may be represented as a 3D point cloud. For instance, vertices of the isometric mesh may correspond to points of a 3D point cloud and/or shape edges of the isometric mesh may correspond to edges between the points of the 3D point cloud. For example, a 3D point cloud may include points that satisfy a criterion or criteria (e.g., equal or approximately equal angles, area, and/or edges) to form an isometric mesh.

In some examples of the techniques described herein, a machine learning model may be utilized to predict or infer a compensated point cloud. A compensated point cloud is a point cloud that is compensated for potential or anticipated deformation (e.g., deformation from manufacturing). A compensated point cloud may be an example of the compensated model described herein. For instance, the compensated point cloud may represent a 3D object model that is compensated for deformation from manufacturing. The machine learning model may predict or infer the compensated point cloud of the object based on an object model point cloud (e.g., isometric mesh) of a 3D object model (e.g., CAD model). In some examples, each point of the object model point cloud may be utilized and/or compensation prediction may be performed for all points of the object model point cloud.

In some examples of the techniques described herein, a machine learning model may be utilized to predict a deformed point cloud representing a manufactured object (before the object is manufactured and/or independent of object manufacturing, for instance). In some examples, the machine learning model may predict the deformed point cloud of the object (e.g., object deformation) based on an object model point cloud and/or a compensated point cloud. In some examples, each point of the object model point cloud may be utilized and/or deformation prediction may be performed for all points of the object model point cloud.

In some examples, a machine learning model or machine learning models may be trained using a point cloud or point clouds. For example, machine learning models may be trained using object model point clouds (e.g., isometric meshes) and scanned object point clouds. For instance, a 3D object model or models may be utilized to manufacture (e.g., print) a 3D object or objects. An object model point cloud or clouds may be determined from the 3D object model(s). A scanned object point cloud or point clouds may be obtained by scanning the manufactured 3D object or objects. In some examples, training data for training the machine learning models may include the scanned point clouds after alignment to the object model point clouds.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

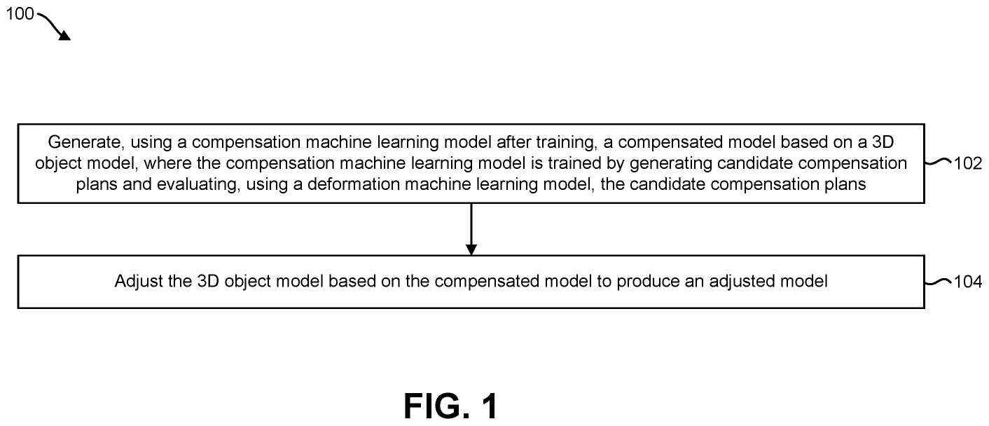

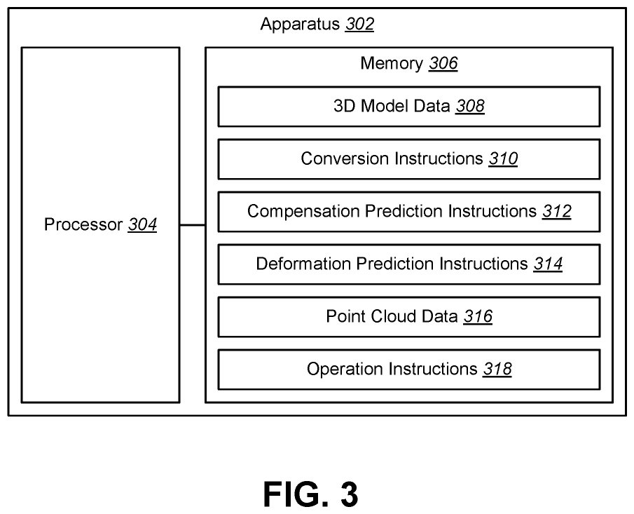

FIG. 1 is a flow diagram illustrating an example of a method 100 for model compensation. The method 100 and/or an element or elements of the method 100 may be performed by an apparatus (e.g., electronic device). For example, the method 100 may be performed by the apparatus 302 described in connection with FIG. 3.

The apparatus may generate 102, using a compensation machine learning model after training, a compensated model based on a 3D object model. A compensation machine learning model is a machine learning model for predicting or inferencing a compensated model or models (e.g., candidate compensation plans). The compensation machine learning model may be trained by generating candidate compensation plans and evaluating, using a deformation machine learning model, the candidate compensation plans. In some examples, the candidate compensation plans are evaluated to produce a selected compensation plan. For instance, the apparatus may utilize a compensation machine learning model to generate 102 the candidate compensation plans. A candidate compensation plan is a compensated model that may be evaluated, selected, and/or utilized to compensate for deformation (e.g., anticipated deformation, predicted deformation, etc.). During training, the compensation machine learning model may generate the candidate compensation plans. In some examples, the compensation machine learning model may be trained with a training object model point cloud or clouds. A training object model point cloud is an object model point cloud used for training. For example, training object model point clouds may be utilized to train a machine learning model before prediction or inferencing. In some examples, the compensation machine learning model may be a GNN (e.g., first GNN). In some examples, training and prediction or inferencing may be performed on the same device (e.g., the apparatus) or different devices. For instance, a first device may train the compensation machine learning model and the trained compensation machine learning model may be provided to another device (e.g., the apparatus) for prediction or inferencing.

In some examples, the method 100 may include converting the 3D object model to an isometric mesh. For instance, the apparatus may sample the 3D object model to produce polygons (e.g., triangles) with a parameter or parameters that are the same, similar, or within a range. In some examples, the apparatus may utilize a discrete diffusion procedure to convert the 3D object model to an isometric mesh. For instance, the apparatus may sample an initial point on the 3D object model and may iteratively sample points on the surface of the 3D at approximately a distance d in relation to a previous point(s) in an expanding manner. In some examples, isometric mesh conversion may be performed during a training stage and/or a prediction or inferencing stage. For example, generating the candidate compensation plans during training may include inputting an isometric mesh or meshes into the compensation machine learning model. The compensation machine learning model may be trained to utilize an isometric mesh to generate 102 the compensated model. In some examples, generating 102 the compensated model may include inputting the isometric mesh into the compensation machine learning model.

In some examples, the isometric mesh may be represented as 3D point cloud. For instance, the 3D object model may be sampled to produce the 3D point cloud. In some examples, the isometric mesh and/or the 3D point cloud may include static edges. For instance, edges in the isometric mesh and/or in the 3D point cloud may be unchanging.

In some examples, the compensation machine learning model may be trained by evaluating, using a deformation machine learning model, the candidate compensation plans to produce a selected compensation plan. A deformation machine learning model is a machine learning model to predict a deformed model or models (e.g., deformed candidate compensation plans). For instance, the apparatus may utilize a deformation machine learning model to predict deformations to the candidate compensation plans to produce deformed candidate compensation plans. A deformed candidate compensation plan is a deformed model of a candidate compensation plan.

In some examples, the deformed candidate compensation plans may be compared to training data (e.g., training 3D object model(s), training object model point cloud(s), etc.) to determine the selected compensation plan. Comparing the deformed candidate compensation plans with the training data may include determining a metric or metrics that indicate a comparison. For instance, the apparatus may determine a difference, distance, error, loss, similarity, and/or correlation between each of the deformed candidate compensation plans and a training 3D object model. For instance, a training 3D object model may be an object model utilized for training. In some examples, the training 3D object model may be expressed as a training object model point cloud. Some examples of comparison metrics may include Euclidean distance(s) between a deformed candidate compensation plan and a training 3D object model, average (e.g., mean, median, and/or mode) distance between a deformed candidate compensation plan and a training 3D object model, a variance between a deformed candidate compensation plan and a training 3D object model, a standard deviation between a deformed candidate compensation plan and a training 3D object model, a difference or differences between a deformed candidate compensation plan and a training 3D object model, average difference between a deformed candidate compensation plan and a training 3D object model, mean-squared error between a deformed candidate compensation plan and a training 3D object model, etc.

In some examples, the candidate compensation plan corresponding to the lowest difference, distance, error, and/or loss (and/or greatest similarity and/or correlation) may be determined as the selected compensation plan. In some examples, the deformation machine learning model may be a GNN (e.g., second GNN).

In some examples, the apparatus may determine an illustration or illustrations (e.g., plot(s), image(s), etc.) that indicate the comparison(s). For instance, the apparatus may produce a plot that illustrates the selected compensation plan with a training 3D object model, a plot that illustrates a degree of error or difference over the surface of a training 3D object model (or deformed candidate compensation plan), etc.

In some examples, the apparatus may provide the selected compensation plan. For instance, the apparatus may store the selected compensation plan and/or comparison, may send the selected compensation plan and/or comparison to another device, and/or may present the selected compensation plan and/or comparison (on a display and/or in a user interface, for example). In some examples, the selected compensation plan may be utilized for feedback to a training 3D object model. For instance, the selected compensation plan may be utilized to compensate for any remaining disparity between the deformed model (corresponding to the selected compensation plan) and the training 3D object model.

In some examples, the deformation machine learning model may be trained based on a scanned object. The training 3D object model may be manufactured (e.g., printed) to produce an object that has undergone deformation. The object may be scanned to produce a training scanned object point cloud. In some examples, the deformation machine learning model may be trained with a training object model point cloud or clouds as input and a training scanned object point cloud or clouds as a ground truth. In some examples, training scanned object point clouds and/or training object model point clouds may be utilized to train the deformation machine learning model before prediction or inferencing. In some examples, the training object model point cloud(s) may be the same as or different from the training object model point cloud(s) utilized to train the compensation machine learning model. In some examples, the training 3D object model may be converted to an isometric mesh. For instance, the isometric mesh may be represented as a training object model point cloud.

In some examples, the deformation machine learning model may be trained with a loss function based on an L2 loss and/or a chamfer loss. In some examples, the L2 loss (e.g., means square loss) may be utilized to compute regression between the training object model point cloud (e.g., isometric mesh) and the training scanned object point clouds. The L2 loss may be expressed in accordance with Equation (1).

$$L {2}_{loss} = \frac{1}{n} {\sum }_{i = 0}^{n} {( {a}_{i} - {b}_{i} )}^{2} \qquad ( 1 )$$

In Equation (1), aᵢ denotes a point of a training object model point cloud (e.g., isometric mesh) with index i, bᵢ denotes a point of a training scanned object point cloud (e.g., isometric mesh) with index i, and n denotes a number of points. In some examples, the L2 loss may not provide shape coherence, such that the L2 loss may cause some oscillations or other irregular patterns. In some examples, a chamfer loss may be utilized (to preserve shape coherence, for instance). The chamfer loss may be expressed in accordance with Equation (2).

$${Chamfer}_{loss} = {\sum }_{a ∈ {S}_{1}} {min}_{b ∈ {S}_{2}} ‖ a - b ‖ + {\sum }_{b ∈ {S}_{2}} {min}_{a ∈ {S}_{1}} ‖ a - b ‖ \qquad ( 2 )$$

In Equation (2), S₁ is a set of points of a training object model point cloud (e.g., isometric mesh) and S₂ is a set of points of a training scanned object point cloud.

In some examples, a loss function used to train the deformation machine learning model may be expressed in accordance with Equation (3).

$${Deformation}_{loss} = L {2}_{loss} + {Chamfer}_{loss} \qquad ( 3 )$$

Equation (3) expresses the deformation loss as a combination (e.g., sum) of the L2 loss and the chamfer loss. While the L2 loss, the chamfer loss, and the deformation loss are expressed in terms of a training stage, the L2 loss, the chamfer loss, and/or the deformation loss may be utilized during inferencing in some approaches. For instance, the metric for comparison may be based on the L2 loss, the chamfer loss, and/or the deformation loss. For example, the L2 loss, the chamfer loss, and/or the deformation loss may be calculated and utilized to produce the selected compensation plan.

In some examples, the compensation machine learning model may be trained while weights of the deformation machine learning model are locked. For instance, after the deformation machine learning model is trained, weights of the deformation machine learning model may be locked to train the compensation machine learning model.

For instance, some approaches may provide a simplified training strategy by training the deformation machine learning model first. Then, the weights (e.g., parameters) of the deformation machine learning model may be locked. In some examples, the compensation machine learning model may be trained and evaluated while the parameters of the deformation machine learning model are locked. In some examples, training the deformation machine learning model and the compensation machine learning model separately may provide increased stability for the machine learning model architecture. In some examples, the simplified training strategy may be equivalent to a generative adversarial network (GAN) training strategy, assuming that the deformation machine learning model is accurately trained (e.g., the discriminator is accurately trained). In some examples, the trained compensated machine learning model may be deterministic. For instance, for a 3D object model at a same location in a build volume, the output (e.g., compensated model) may be the same. In some examples, some compensated models may be different for a same 3D object model at different locations in a build volume due to differing thermal histories and/or physical processes at the different locations (of the build volume, for instance).

In some examples, the apparatus may adjust 104 the 3D object model based on the compensated model to produce an adjusted model. For instance, the apparatus may adjust 104 the 3D object model to match the compensated model. In some examples, adjusting 104 the 3D object model may include utilizing the compensated model (instead of the original 3D object model, for instance) for printing. In some examples, the method 100 may include printing a 3D object based on the compensated model. For instance, the apparatus may utilize the 3D object model that is adjusted 104 based on the compensated model to print the 3D object. For instance, the apparatus may be a 3D printer and may utilize the adjusted 3D object model to print the 3D object. In some examples, the apparatus may send the adjusted 3D object model (e.g., the compensated model) to a 3D printer for printing.

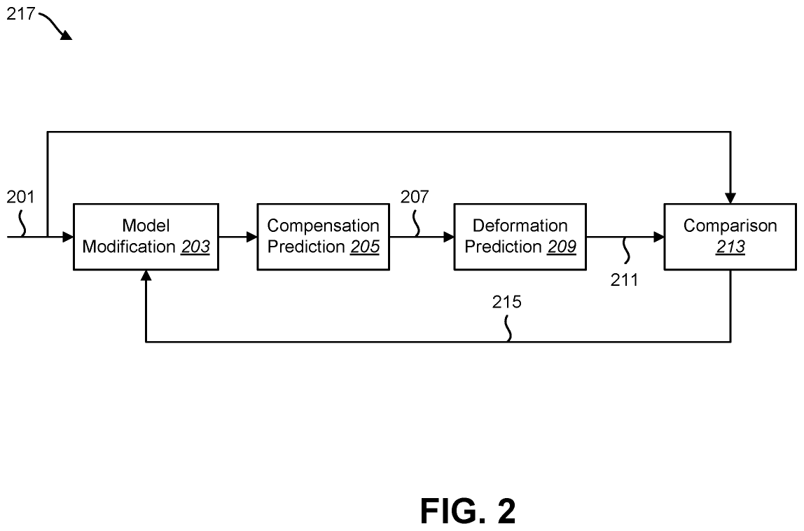

FIG. 2 is a block diagram illustrating an example of an architecture 217 that may be utilized in accordance with some examples of the techniques described herein. In some examples, an engine or engines of the architecture 217 described in relation to FIG. 2 may be implemented in the apparatus 302 described in relation to FIG. 3. In some examples, a function or functions described in relation to any of FIGS. 1-5 may be implemented in an engine or engines described in relation to FIG. 2. An engine or engines described in relation to FIG. 2 may be implemented in a device or devices, in hardware (e.g., circuitry) and/or in a combination of hardware and instructions or code (e.g., processor and instructions). The engines described in relation to FIG. 2 include a model modification engine 203, compensation prediction engine 205, a deformation prediction engine 209, and a comparison engine 213.

In some examples, the architecture 217 may include aspects of a GAN architecture. For instance, some of the engines described in relation to FIG. 2 may perform functions of a GAN. In some examples, a GAN may include two neural networks: a generator and a discriminator. In the example of FIG. 2, the generator may be the compensation prediction engine 205, which may propose compensation plans for 3D object model(s) 201. In this example, the discriminator may be the deformation prediction engine 209, which may evaluate the quality of the proposed compensation plans. In some examples, GAN architectures may be difficult to train due to two neural networks being trained together and iteratively.

In some examples of the techniques described herein, a training 3D object model 201 may be provided to the model modification engine 203. Initially, the model modification engine 203 may pass the training 3D object model 201 without adjustment. For instance, the model modification engine 203 may provide the training 3D object model 201 to the compensation prediction engine 205. In some examples, the training 3D object model 201 may be converted to an isometric mesh and/or training point cloud.

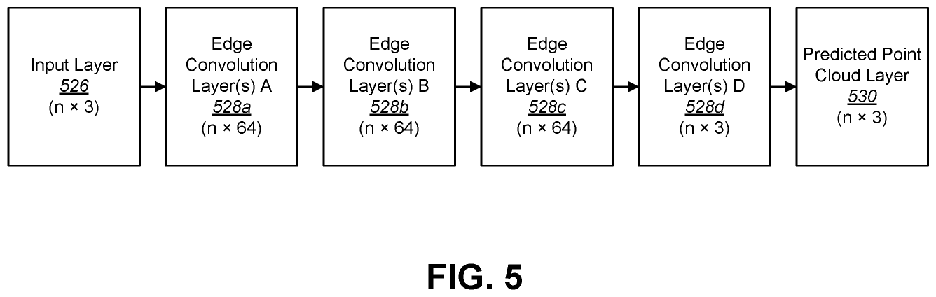

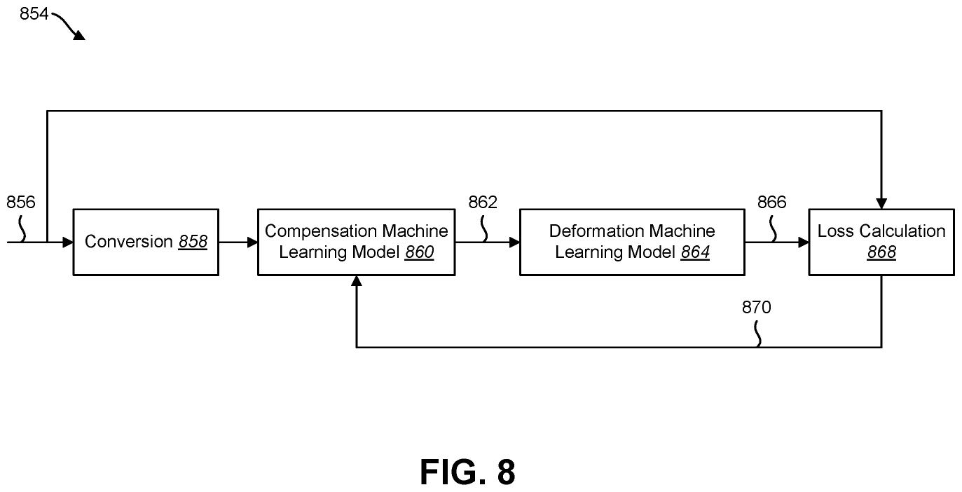

The compensation prediction engine 205 may include and/or execute a compensation machine learning model. In some examples, the compensation machine learning model may be structured as described in relation to FIG. 5. In some examples, the compensation machine learning model may be trained as described in relation to FIG. 8. After the compensation machine learning model is trained, in the prediction or inferencing phase, a 3D object model (e.g., isometric mesh and/or object model point cloud) with target geometry may be utilized as input to predict a compensated model (e.g., compensated CAD model, compensated point cloud, etc.). For example, the compensation prediction engine 205 may utilize a 3D object model to generate a compensated model that may be utilized to reduce error after printing.

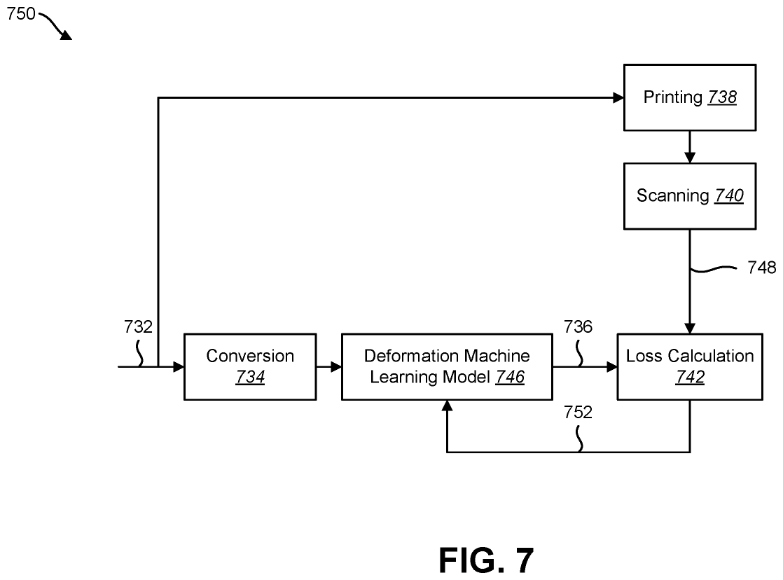

The compensated model 207 may be utilized by the deformation prediction engine 209 to produce a deformed model 211 (e.g., deformed compensated model, deformed point cloud, etc.). The deformation prediction engine 209 may include and/or execute a deformation machine learning model. In some examples, the deformation machine learning model may be structured as described in relation to FIG. 5. In some examples, the deformation machine learning model may be trained as described in relation to FIG. 7. The deformation prediction engine 209 may predict deformation of the compensated model 207 to produce the deformed model 211. The compensation prediction engine 205 and the deformation prediction engine 209 may be utilized to find a compensated model (e.g., compensated model plan) where the deformed model 211 geometry approaches the training 3D object model 201 geometry.

In some examples, the training 3D object model 201 and the deformed model 211 may be provided to a comparison engine 213. The comparison engine 213 may produce comparison information 215, which may indicate a comparison or comparisons of the training 3D object model 201 and the deformed model 211. Examples of the comparison information 215 may include the metrics (e.g., difference, distance, error, loss, similarity, correlation, variance, standard deviation, etc.) described in relation to FIG. 1. For example, the comparison engine 213 may determine the comparison information 215, which may indicate a degree of difference and/or matching between the deformed model 211 and the training 3D object model 201. The comparison information 215 may be provided to the model modification engine 203.

The comparison information 215 may be data-driven feedback. For example, the model modification engine 203 may utilize the comparison information 215 to modify the training 3D object model 201 to increase conformance of the deformed model 211 to the training 3D object model 201. In some examples, the model modification engine 203 may utilize the predicted compensation and/or compensated model as the modified model. In some examples, the model modification engine 203 may modify the training 3D object model 201 by selecting the predicted compensation and/or compensated model corresponding to comparison information 215 indicating a disparity and/or similarity that satisfies a criterion (e.g., minimum or threshold disparity, difference, error, loss, etc., and/or maximum or threshold similarity or correlation). In some examples, the selected predicted compensation and/or compensated model may be utilized as the modified model. In some examples, the training 3D object model 201 may be changed according to the selected compensation and/or to conform to the selected compensated model. For instance, the input training 3D object model 201 may be replaced with the compensated model and/or the selected compensated plan. The modification may be utilized to increase printing accuracy. For instance, similar modification(s) may be applied to a 3D object model during an inferencing or prediction stage (e.g., after training). In some examples, the compensation machine learning model may be trained to reduce the disparity between a compensated model and the training 3D object model. During prediction or inferencing (e.g., after training), the compensation machine learning model may generate a compensated model (with a reduced disparity, for instance) that may be utilized to print the object.

FIG. 3 is a block diagram of an example of an apparatus 302 that may be used in model compensation. The apparatus 302 may be a computing device, such as a personal computer, a server computer, a printer, a 3D printer, a smartphone, a tablet computer, etc. The apparatus 302 may include and/or may be coupled to a processor 304, and/or to a memory 306. The processor 304 may be in electronic communication with the memory 306. In some examples, the apparatus 302 may be in communication with (e.g., coupled to, have a communication link with) an additive manufacturing device (e.g., a 3D printing device) and/or a scanning device. In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., conversion instructions 310, compensation prediction instructions 312, deformation prediction instructions 314, and/or operation instructions 318) stored in the memory 306. In some examples, the processor 304 may include an electronic circuit or circuits that include electronic components for performing a functionality or functionalities of the instructions (e.g., conversion instructions 310, compensation prediction instructions 312, deformation prediction instructions 314, and/or operation instructions 318). In some examples, the processor 304 may perform one, some, or all of the functions, operations, elements, methods, etc., described in connection with one, some, or all of FIGS. 1-8.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random-Access Memory (DRAM), EEPROM, magnetoresistive random-access memory (MRAM), phase change RAM (PCRAM), memristor, flash memory, and the like. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and/or store information pertaining to an object or objects for which compensation and/or deformation may be predicted. The input/output interface may include hardware and/or machine-readable instructions to enable the processor 304 to communicate with the external device or devices. The input/output interface may enable a wired and/or wireless connection to the external device or devices. In some examples, the input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions into the apparatus 302. In some examples, the apparatus 302 may receive 3D model data 308 from an external device or devices (e.g., 3D scanner, removable storage, network device, etc.).

In some examples, the memory 306 may store 3D model data 308. The 3D model data 308 may be generated by the apparatus 302 and/or received from another device. Some examples of 3D model data 308 include a 3D manufacturing format (3MF) file or files, a 3D computer-aided design (CAD) image, object shape data, mesh data, geometry data, etc. The 3D model data 308 may indicate the shape of an object or objects.

In some examples, the memory 306 may store point cloud data 316. The point cloud data 316 may be generated by the apparatus 302 and/or received from another device. Some examples of point cloud data 316 include an object model point cloud or point clouds generated from the 3D model data 308, a scanned object point cloud or point clouds from a scanned object or objects, a compensated point cloud or point clouds, a deformed point cloud or point clouds, and/or an isometric mesh or meshes. For example, the processor 304 may determine an isometric mesh represented as a 3D point cloud converted from a 3D object model indicated by the 3D model data 308. The isometric mesh may be stored with the point cloud data 316. In some examples, the apparatus 302 may receive a 3D scan or scans of an object or objects from another device (e.g., linked device, networked device, removable storage, etc.) or may capture the 3D scan that may indicate a scanned object point cloud.

The memory 306 may store conversion instructions 310. The processor 304 may execute the conversion instructions 310 to convert a 3D object model to an isometric mesh. The isometric mesh may be represented as a 3D point cloud. In some examples, converting the 3D object model to an isometric mesh may be performed as described in relation to FIG. 1.

The memory 306 may store compensation prediction instructions 312. The processor 304 may execute the compensation prediction instructions 312 to predict, using a compensation machine learning model, compensation of the 3D object model based on the isometric mesh. For instance, the processor 304 may use a compensation machine learning model to predict the compensation based on the isometric mesh. In some examples, the compensation machine learning model may be trained based on a previous training of a deformation machine learning model. For instance, a deformation machine learning model may be trained first, and may be utilized to train the compensation machine learning model as described herein.

In some examples, the processor 304 may execute the compensation prediction instructions 312 to produce a graph based on the isometric mesh. For instance, the isometric mesh may be represented as a graph and/or 3D point cloud to work with a GNN or GNNs.

In some examples, the compensation machine learning model described herein may be a first GNN and/or the deformation machine learning model described herein may be a second GNN. A GNN may work differently from other neural networks that utilize inputs with underlying Euclidean structure. For example, some of the techniques described herein may utilize nodes, edges, and/or faces that represent the 3D object model (e.g., CAD), isometric mesh, and/or point clouds. In some examples, a GNN may apply convolution to non-Euclidean data. For instance, a GNN may include multiple edge convolution layers as described in relation to FIG. 5. In some examples, an edge convolution layer may create a graph by determining neighboring nodes, determining edge features, and/or convolving edge features.

In some examples, the processor 304 may execute the compensation prediction instructions 312 to generate a graph by determining edges for each point of the object model point cloud and/or isometric mesh. In some examples, the graph may include the determined edges with points of the object model point cloud and/or isometric mesh as vertices. In some examples, the apparatus 302 may generate a graph for an isometric mesh or meshes, the object model point cloud(s), a compensated point cloud(s), a deformed point cloud(s), and/or a scanned point cloud(s). For example, generating a graph may be performed for a training point cloud(s) and/or for point cloud(s) for prediction or inferencing. In some examples, generating a graph may be performed by the compensation machine learning model and/or the deformation machine learning model.

In some examples, the apparatus 302 (e.g., processor 304) may determine edges from an object model point cloud and/or isometric mesh. An edge is a line or association between points. In some examples, the apparatus 302 may determine edges from the object model point cloud by determining neighbor points for each point of the object model point cloud. A neighbor point is a point that meets a criterion relative to another point. For example, a point or points that are nearest to (e.g., within a threshold distance from) another point (in terms of Euclidean distance, for example) may be a neighbor point or neighbor points relative to the other point. In some examples, the edges may be determined as lines or associations between a point and corresponding neighbor nodes (e.g., points, vertices, etc.).

In some examples, the apparatus 302 (e.g., processor 304) may determine a graph (e.g., nodes and/or edges) based on information from an isometric mesh. For instance, edges of the polygons of the isometric mesh may be utilized as the edges for the graph. In some examples, the polygons of the isometric mesh may include a set of nodes and a set of edges between nodes. For instance, the isometric mesh may form a graph structure without further computation in some approaches.

In some examples, the apparatus 302 (e.g., processor 304) may determine the nearest neighbors using a K nearest neighbors (KNN) approach. For example, K may be a value that indicates a threshold number of neighbor points. For instance, the apparatus 302 may determine the K points that are nearest to another point as the K nearest neighbors.

In some examples, the apparatus 302 (e.g., processor 304) may generate edges between a point and the corresponding neighbor points. For instance, the apparatus 302 may store a record of each edge between a point and the corresponding neighbor points. In some approaches, a point (of a point cloud and/or isometric mesh, for instance) may be denoted xᵢ=(xᵢ, yᵢ, zᵢ) where xᵢ is a location of the point in an x dimension or width dimension, yᵢ is a location of the point in a y dimension or depth dimension, zᵢ is a location of the point in a z dimension or height dimension, and i is an index for a point cloud. For instance, for each point xᵢ, the apparatus 302 (e.g., processor 304) may find neighbor points (e.g., KNN). The apparatus 302 (e.g., processor 304) may generate edges between each point and corresponding neighbor points.

In some examples, determining the edges may generate a graph G=(V, E), where V are the points (e.g., vertices, nodes, etc.) and E are the edges of the graph G. A graph is a data structure including a vertex or vertices and/or an edge or edges. An edge may connect two vertices. In some examples, a graph may or may not be a visual display or plot of data. For example, a plot or visualization of a graph may be utilized to illustrate and/or present a graph.

In some examples, determining the edges may be based on distance metrics. For instance, the apparatus 302 (e.g., processor 304) may determine a distance metric between a point and a candidate point. A candidate point is a point in the point cloud that may potentially be selected as a neighbor point. In some examples, the neighbor points (e.g., KNN) may be determined in accordance with a Euclidean distance as provided in Equation (4).

$$d ( {x}_{i} , {x}_{j} ) = \sqrt{{( {x}_{i} , {x}_{j} )}^{2} + {( {y}_{i} , {y}_{j} )}^{2} + {( {z}_{i} , {z}_{j} )}^{2}} \qquad ( 4 )$$

In Equation (4), j is an index for points where j≠i. The K candidate points that are nearest to the point may be selected as the neighbor points and/or edges may be generated between the point and the K nearest candidate points. In some examples, K may be a given value, may be static, may be adjustable, or may be determined based on a user input.

In some examples, the apparatus 302 (e.g., processor 304) may determine a local value for each of the edges. A local value is a value (or vector of values) that indicates local neighborhood information to simulate a thermal diffusion effect. In some examples, the local value may be determined as (xⱼ^{(m)})−xᵢ^{(m)}. For instance, the local value may be a difference between the point and a neighbor point. In some examples, the local value may be weighted with a local weight θₘ (e.g., θₘ·(xⱼ^{(m)}−xᵢ^{(m)})). In some examples, the local weight may be estimated during machine learning model training for learning local features and/or representations. For instance, θₘ·(xⱼ^{(m)}−xᵢ^{(m)}) may capture local neighborhood information, with a physical insight to simulate more detailed thermal diffusive effects. Examples of the local weight may be in a relatively large range of numbers and may be negative or positive.

In some examples, the apparatus 302 (e.g., processor 304) may determine a combination of the local value and a global value for each of the edges. For instance, a GNN may provide global shape information and local shape information. A global value is a value that indicates global information to simulate a global thermal mass effect. For instance, the global value may be the point xᵢ^{(m)}. In some examples, the global value may be weighted with a global weight ϕₘ (e.g., ϕₘ·xᵢ^{(m)}). In some examples, the global weight may be estimated during machine learning model training for learning a global deformation effect on each point. For instance, ϕₘ·xᵢ^{(m)} may explicitly adopt global shape structure, with a physical insight to simulate the overall thermal mass. In some examples, determining the combination of the local value and the global value for each of the edges may include summing the local value and the global value (with or without weights) for each of the edges. For instance, the apparatus 302 (e.g., processor 304) may calculate θₘ·(xⱼ^{(m)}−xᵢ^{(m)})+ϕₘ·xᵢ^{(m)}. Examples of the global weight may be in a relatively large range of numbers and may be negative or positive.

In some examples, the processor 304 may determine an edge feature for each of the edges of the graph. For example, the apparatus 302 (e.g., processor 304) may determine an edge feature for each of the edges determined from a point cloud (e.g., object model point cloud, compensated point cloud, etc.). An edge feature is a value (or vector of values) that indicates a relationship between points (e.g., neighbor points). In some examples, an edge feature may represent a geometrical structure associated with an edge connecting two points (e.g., neighbor points). In some examples, the processor 304 may determine a local value for each of the edges, may determine a combination of the local value and a global value for each of the edges, and/or may apply an activation function to each of the combinations to determine the edge feature.

In some examples, the apparatus 302 (e.g., processor 304) may determine an edge feature based on the combination of the local value and the global value for each of the edges. In some examples, the apparatus 302 (e.g., processor 304) may determine the edge feature by applying an activation function to the combination for each of the edges. For instance, the apparatus 302 (e.g., processor 304) may determine the edge feature in accordance with Equation (5).

$${e}_{ij}^{( m )} = Re LU ( {θ}_{m} \cdot ( {x}_{j}^{( m )} - {x}_{i}^{( m )} ) + {ϕ}_{m} \cdot {x}_{i}^{( m )} ) \qquad ( 5 )$$

In Equation (5), eᵢⱼ^{(m)} is the edge feature, m is a layer depth index (e.g., index of a convolution layer) for a machine learning model (e.g., convolutional neural network, compensation machine learning model, and/or deformation machine learning model), and ReLU is a rectified linear unit activation function. For example, xᵢ^{(m)} may denote features of xᵢ after an m-th convolution. For instance, the rectified linear unit activation function may take a maximum of 0 and the input value. Accordingly, the rectified linear unit activation function may output zeros for negative input values and may output values equal to positive input values. In some examples, determining the edge feature may be performed (at an edge convolution layer) at each convolution channel m for each edge in the graph.

In some examples, the apparatus 302 (e.g., processor 304) may convolve the edge features to predict a point cloud. For example, the apparatus 302 may convolve edge features to predict compensation (e.g., a compensated point cloud) or deformation (e.g., a deformed point cloud). In some examples, the apparatus 302 (e.g., processor 304) may convolve the edge features by summing edge features. For instance, the apparatus 302 (e.g., processor 304) may convolve the edge features in accordance with Equation (6).

$${x}_{i}^{′ ( m )} = {\sum }_{j : ( i , j ∈ E )} {e}_{ij}^{( m )} \qquad ( 6 )$$

In Equation (6), X′ᵢ^{(m)} is a point of the predicted point cloud after an m-th convolution of edge features (e.g., an i-th vertex). As illustrated by Equation (6), convolution on the graph (e.g., KNN graph) is transferred to a regular convolution. Accordingly, some of the techniques described herein enable a machine learning model (e.g., convolutional neural network) to predict object compensation (e.g., point-cloud-wise object compensation) and/or object deformation (e.g., point-cloud-wise object deformation) using a point cloud or point clouds (e.g., object model point cloud, compensated point cloud).

In some examples, the processor 304 may execute the compensation prediction instructions 312 to predict the compensation (e.g., compensated point cloud) of the 3D object model based on the isometric mesh. For example, executing the compensation prediction instructions 312 with the isometric mesh as input may produce the predicted compensation (e.g., compensated point cloud). For instance, the apparatus 302 (e.g., processor 304) may generate a graph from the isometric mesh, may determine edge features from the graph, and/or may convolve the edge features to predict the compensation (e.g., compensated point cloud).

The memory 306 may store deformation prediction instructions 314. In some examples, the processor 304 may execute the deformation prediction instructions 314 to predict, using a deformation machine learning model, deformation (e.g., a deformed point cloud) of the 3D object model based on the compensation (e.g., compensated point cloud). In some examples, the deformation may be expressed as a deformed point cloud. For instance, the apparatus 302 (e.g., processor 304) may use a deformation machine learning model to predict a deformed point cloud based on the compensated point cloud.

In some examples, the apparatus 302 may generate a graph for the compensated point cloud and/or may determine edge features for the compensated point cloud as described above. For instance, the deformation machine learning model may generate a graph as described above for a compensated point cloud. For instance, the deformation machine learning model may utilize the KNN techniques described above to determine edges for the compensated point cloud. In some examples, the deformation machine learning model may determine an edge feature as described above (e.g., in accordance with Equation (5)) for the compensated point cloud. In some examples, the deformation machine learning model may convolve the edge features to predict a deformed point cloud as described above (e.g., in accordance with Equation (6)). In some examples, the processor 304 may execute the deformation prediction instructions 314 to predict, based on the edge features (from the compensated point cloud, for instance), a deformed point cloud. In some cases, the deformation prediction may be performed before, during, or after (e.g., independently from) 3D printing of the object. In some examples, the deformation machine learning model may include edge convolution layers to generate a graph, determine edge features, and/or convolve the edge features.

In some examples, the processor 304 may execute the operation instructions 318 to perform an operation. For example, the apparatus 302 may perform an operation based on the predicted compensation (e.g., compensated point cloud) and/or based on the predicted deformation (e.g., the deformed point cloud). For instance, the processor 304 may present the compensated point cloud and/or the deformed point cloud on a display, may present a comparison of the compensated point cloud and 3D object model on a display, may store the compensated point cloud and/or the deformed point cloud in the memory 306, and/or may send the compensated point cloud and/or the deformed point cloud to another device or devices.

In some examples, the processor 304 may execute the operation instructions 318 to determine whether the compensation (e.g., compensated point cloud) satisfies a condition based on the deformation. Examples of conditions may include a deformation threshold, a loss threshold, quality threshold, etc. For instance, the processor 304 may determine whether a metric of the deformation satisfies the condition. In some examples, the apparatus 302 (e.g., processor 304) may compare point clouds. For example, the apparatus 302 may compare the deformed point cloud with the object model point cloud. In some examples, the apparatus 302 may perform a comparison to determine a metric or metrics as described in relation to FIG. 1. In some examples, the apparatus 302 may provide and/or present the comparison(s). In some examples, if the deformation satisfies the condition (e.g., if the metric satisfies a loss threshold), the compensated model (e.g., compensated point cloud, compensation plan, etc.) may be selected. In some examples, the selected compensated model may be utilized to adjust a 3D object model and/or may be utilized to print the 3D object as described in relation to FIG. 1.

In some examples, the apparatus 302 (e.g., processor 304) may manufacture (e.g., print) an object. For example, the apparatus 302 may print an object based on the compensated point cloud as described in relation to FIG. 1. For instance, the processor 304 may drive model setting based on a deformation-compensated 3D model that is based on the compensated point cloud and/or the deformed point cloud. In some examples, the object or objects may be scanned to produce a scanned object point cloud or clouds.

In some examples, the processor 304 may train a machine learning model or models. For example, the processor 304 may train the compensation machine learning model and/or the deformation machine learning model using point cloud data 316.

Some machine learning approaches may utilize training data to predict or infer object compensation and/or object deformation. The training data may indicate deformation that has occurred during a manufacturing process. For example, object deformation may be assessed based on a 3D object model (e.g., computer aided drafting (CAD) model) and a 3D scan of an object that has been manufactured based on the 3D object model. The object deformation assessment (e.g., the 3D object model and the 3D scan) may be utilized as a ground truth for machine learning. For instance, the object deformation assessment may enable deformation prediction and/or compensation prediction. In order to assess object deformation, the 3D object model and the 3D scan may be registered. Registration is a procedure to align objects. For instance, a 3D object model and a 3D point cloud may not be initially aligned (e.g., scanned objects may not be co-aligned with 3D objects in a build volume). The misalignment may be due to global coordinates that are rotated and shifted during scanning procedures of the printed objects. The scanned objects may not be identical to the 3D object models due to geometric deformation during the printing procedures. Registration techniques may be utilized to align a 3D object model and a 3D scan (e.g., 3D point cloud).

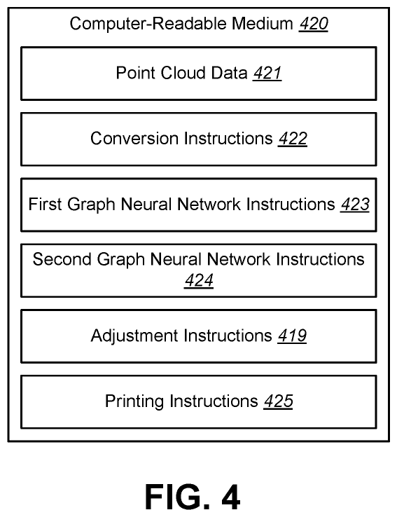

FIG. 4 is a block diagram illustrating an example of a computer-readable medium 420 for model compensation. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 420 described in connection with FIG. 4.

The computer-readable medium 420 may include data (e.g., information and/or instructions). For example, the computer-readable medium 420 may include point cloud data 421, conversion instructions 422, first graph neural network instructions 423, second graph neural network instructions 424, adjustment instructions 419, and/or printing instructions 425.

In some examples, the computer-readable medium 420 may store point cloud data 421. Some examples of point cloud data 421 include samples of a 3D object model (e.g., 3D CAD file), point cloud(s), and/or scan data, etc. The point cloud data 421 may indicate the shape of a 3D object (e.g., an actual 3D object or a 3D object model).

In some examples, the conversion instructions 422 may be instructions when executed cause a processor of an electronic device to convert a 3D object model to an isometric mesh. In some examples, converting the 3D object model to the isometric mesh may be accomplished as described in relation to FIG. 1.

In some examples, the first graph neural network instructions 423 may be instructions when executed cause the processor to predict, using a first graph neural network, a compensated point cloud indicating compensation to the 3D object model based on a first graph structure of the isometric mesh. In some examples, predicting the compensated point cloud may be accomplished as described in relation to FIG. 1, FIG. 2, and/or FIG. 3. For instance, the first graph neural network instructions 423 may be executed to determine neighbor points and edges for each point of the isometric mesh to produce the first graph structure of the isometric mesh. The first graph neural network instructions 423 may be executed to determine an edge feature for each edge of the first graph and/or to convolve the edge features by the first graph neural network to predict the compensated point cloud.

In some examples, the second graph neural network instructions 424 may be instructions when executed cause the processor to predict, using a second graph neural network, a deformed point cloud indicating deformation to the compensated point cloud based on a second graph structure of the compensated point cloud. In some examples, predicting the deformed point cloud may be accomplished as described in relation to FIG. 1, FIG. 2, and/or FIG. 3. For instance, the second graph neural network instructions 424 may be executed to determine neighbor points and edges for each point of the compensated point cloud to produce the second graph structure of the compensated point cloud. The second graph neural network instructions 424 may be executed to determine an edge feature for each edge of the second graph and/or to convolve the edge features by the second graph neural network to predict the deformed point cloud.

In some examples, the adjustment instructions 419 may be instructions when executed cause the processor to adjust the 3D object model based on the deformed point cloud to produce an adjusted 3D object model. In some examples, this may be accomplished as described in relation to FIG. 1, FIG. 2, and/or FIG. 3.

In some examples, the printing instructions 425 may be instructions when executed cause the processor to print the adjusted 3D object model. In some examples, this may be accomplished as described in relation to FIG. 1, FIG. 2, and/or FIG. 3.

In some examples, the computer-readable medium 420 may include instructions when executed cause the processor to train the second graph neural network based on an L2 loss and a chamfer loss. In some examples, this may be accomplished as described in relation to FIG. 1.

FIG. 5 is a block diagram illustrating an example of a machine learning model architecture. The machine learning model architecture may be an example of the machine learning models described herein. For example, the machine learning model architecture may be utilized for the compensation machine learning model and/or for the deformation machine learning model. The machine learning model architecture includes nodes and layers. For example, the machine learning model architecture includes an input layer 526, edge convolution layer(s) A 528a, edge convolution layer(s) B 528b, edge convolution layer(s) C 528c, edge convolution layer(s) D 528d, and a predicted point cloud layer 530. For some examples of the compensation machine learning model, the input layer 526 may take an object model point cloud (e.g., isometric mesh), and the predicted point cloud layer 530 may provide a compensated point cloud. For some examples of the deformation machine learning model, the input layer 526 may take a point cloud (e.g., isometric mesh and/or compensated point cloud), and the predicted point cloud layer 530 may provide a deformed point cloud.

In the example of FIG. 5, the machine learning model architecture stacks several edge convolution layers 528a-d. While FIG. 5 illustrates one example of a machine learning architecture that may be utilized in accordance with some of the techniques described herein, the architecture is flexible and/or other architectures may be utilized. The input layer 526 may have dimensions of n×3, where n represents n points of the point cloud (e.g., object model point cloud or compensated point cloud, etc.) and 3 represents x, y, and z coordinates. In another example, the machine learning model architecture may have more features as input (e.g., the geometric normal of the x, y, and z coordinates, where an input layer may have dimensions of n×6). In the example of FIG. 5, edge convolution layer(s) A 528a, edge convolution layer(s) B 528b, and edge convolution layer(s) C 528c each have dimensions of n×64. Edge convolution layer(s) D 528d has dimensions of n×3. The predicted point cloud layer 530 has dimensions of n×3. In some examples, more or fewer edge convolution blocks may be utilized, which may include more or fewer edge convolution layers in each block. Beyond edge convolution blocks, other layers (e.g., pooling layers) may or may not be added in some examples.

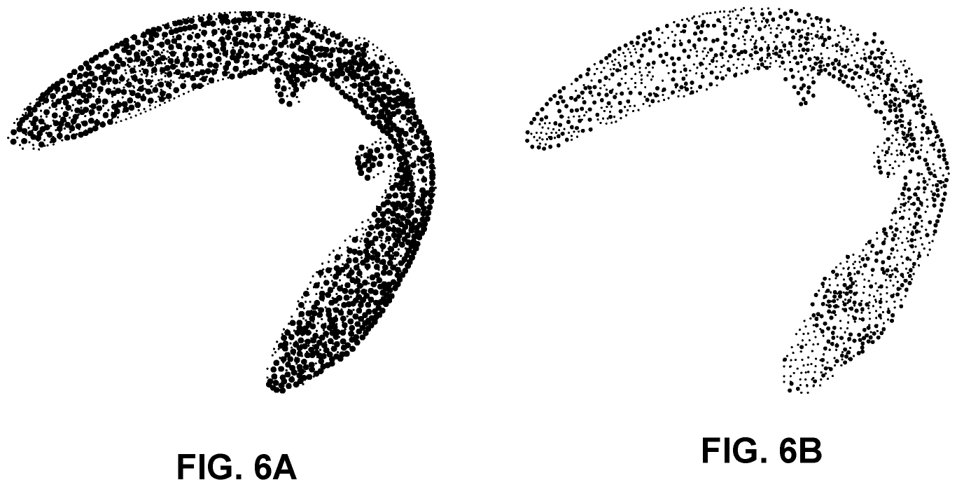

FIG. 6A is a diagram illustrating an example of an object model point cloud. For instance, a point cloud of a 3D object model may be utilized as an object model point cloud in accordance with some of the techniques described herein. In some examples of 3D printing, the 3D object model (e.g., CAD design) may provide data and/or instructions for the object(s) to print. In some examples, an apparatus may slice layers from the 3D object model. The layers may provide the data and/or instructions for actual printing. To enable printing with increased accuracy, the 3D object model may be controlled. The object model point cloud(s) may provide the representation of the 3D object model. In some examples, a 3D object model may be converted to an isometric mesh and provided to a graph neural network that works on the points or nodes of the isometric mesh. To measure and represent the shape (e.g., geometry) of manufactured objects, a 3D scanner may be utilized to measure the geometry of the actual printed objects. The measured shape may be represented as point clouds. The scanned points may be aligned with the points corresponding to the 3D object model, which may enable calculating the deformation. For example, with two datasets: (1) scanned object point clouds and (2) object model point clouds, a machine learning model or models may be developed to provide accurate compensation prediction (e.g., a compensated model, compensated point cloud, etc.) for printing. The number and/or density of the point clouds utilized may be tunable (e.g., experimentally tunable).

FIG. 6B is a diagram illustrating an example of a scanned object point cloud. For instance, the scanned object point cloud of FIG. 6B may be a representation of an object scan. With accurate alignment techniques, the scanned object point cloud may be aligned with points of a 3D object model and utilized to calculate deformation for machine learning model training.

FIG. 7 is a block diagram illustrating an example of an architecture 750 that may be utilized to train a deformation machine learning model in accordance with some examples of the techniques described herein. In some examples, an engine or engines of the architecture 750 described in relation to FIG. 7 may be implemented in the apparatus 302 described in relation to FIG. 3. In some examples, a function or functions described in relation to any of FIGS. 1-6B may be implemented in an engine or engines described in relation to FIG. 7. An engine or engines described in relation to FIG. 7 may be implemented in a device or devices, in hardware (e.g., circuitry) and/or in a combination of hardware and instructions or code (e.g., processor and instructions). The engines described in relation to FIG. 7 include a conversion engine 734, a deformation machine learning model engine 746, a loss calculation engine 742, a printing engine 738, and/or a scanning engine 740.

In some examples of the techniques described herein, a training 3D object model 732 may be provided to the conversion engine 734 and/or to the printing engine 738. The conversion engine 734 may convert the training 3D object model 732 to an isometric mesh. In some examples, this may be accomplished as described in relation to FIG. 1. The isometric mesh may be provided to the deformation machine learning model engine 746.

The deformation machine learning model engine 746 may include and/or execute a deformation machine learning model. In some examples, the deformation machine learning model may be structured as described in relation to FIG. 5. The deformation machine learning model engine 746 may use the isometric mesh to predict a deformed model 736. The deformed model 736 may be provided to the loss calculation engine 742.

The printing engine 738 may produce an object, which may be utilized for scanning. For instance, the printing engine 738 may produce and/or provide printing instructions based on the training 3D object model 732. The printing instructions may be utilized and/or sent to a 3D printer to print an object based on the training 3D object model 732. The scanning engine 740 may produce a scanned model 748 (e.g., scanned object point cloud) of the object. For instance, the scanning engine 740 (e.g., a 3D scanner) may scan the surface geometry of the printed object to produce a scanned model 748 (e.g., scanned object point cloud). For example, a 3D object may be scanned with a 3D scanner (e.g., depth sensor(s), camera(s), LIDAR sensors, etc.) to produce a scanned object point cloud representing the 3D object (e.g., manufactured object, 3D printed object, etc.). The scanned object point cloud may include a set of points representing locations on the surface of the 3D object in 3D space.

In some examples, the scanned model 748 and the deformed model 736 may be provided to the loss calculation engine 742. The loss calculation engine 742 may produce loss information 752. In some examples, the loss information 752 may indicate a loss between the deformed model 736 and the scanned model 748 (e.g., ground truth). Examples of the loss information 752 may include the L2 loss, the chamfer loss, and/or the deformation loss (e.g., the deformation loss described in accordance with Equation (3)), etc. During training, the loss information 752 may be utilized to adjust the weights of the deformation machine learning model.

FIG. 8 is a block diagram illustrating an example of an architecture 854 that may be utilized to train a compensation machine learning model in accordance with some examples of the techniques described herein. In some examples, an engine or engines of the architecture 854 described in relation to FIG. 8 may be implemented in the apparatus 302 described in relation to FIG. 3. In some examples, a function or functions described in relation to any of FIGS. 1-7 may be implemented in an engine or engines described in relation to FIG. 8. An engine or engines described in relation to FIG. 8 may be implemented in a device or devices, in hardware (e.g., circuitry) and/or in a combination of hardware and instructions or code (e.g., processor and instructions). The engines described in relation to FIG. 8 include a conversion engine 858, a compensation machine learning model engine 860, a deformation machine learning model engine 864, and/or a loss calculation engine 868.

In some examples of the techniques described herein, a training 3D object model 856 may be provided to the conversion engine 858 and/or to the loss calculation engine 868. The conversion engine 858 may convert the training 3D object model 856 to an isometric mesh. In some examples, this may be accomplished as described in relation to FIG. 1. The isometric mesh may be provided to the compensation machine learning model engine 860.

The compensation machine learning model engine 860 may include and/or execute a compensation machine learning model. In some examples, the compensation machine learning model may be structured as described in relation to FIG. 5. The compensation machine learning model engine 860 may use the isometric mesh to predict a compensated model 862. The compensated model 862 may be provided to the deformation machine learning model engine 864.

The deformation machine learning model engine 864 may include and/or execute a deformation machine learning model. In some examples, the deformation machine learning model may be structured as described in relation to FIG. 5. The deformation machine learning model engine 864 may use the compensated model 862 to predict a deformed model 866. The deformed model 866 may be provided to the loss calculation engine 868.

In some examples, the training 3D object model 856 and the deformed model 866 may be provided to the loss calculation engine 868. The loss calculation engine 868 may produce loss information 870. In some examples, the loss information 870 may indicate a loss between the deformed model 866 and the training 3D object model 856 (e.g., ground truth). Examples of the loss information 870 may include the L2 loss, the chamfer loss, and/or the deformation loss (e.g., the deformation loss described in accordance with Equation (3)), etc. During training, the loss information 870 may be utilized to adjust the weights of the compensation machine learning model.

The architecture 854 may be utilized to compensate the training 3D object model 856 to reduce (e.g., minimize) disparities between the target geometry and the geometry resulting from printing processes. The compensation machine learning model may provide a geometrically compensated model 862, which may be passed into the deformation machine learning model engine 864. The deformation machine learning model engine 864 may apply a predicted deformation on the compensated model 862, such that the compensated predicted deformed model 866 is geometrically close to the training 3D object model 856. During inferencing, the trained compensation machine learning model and deformation machine learning models may be utilized to predict compensation to reduce resulting disparities for other 3D object models.

In some examples, the architecture 854 may include the conversion engine 858, the compensation machine learning model engine 860, the deformation machine learning model engine 864, and the loss calculation engine 868. In some examples, the compensation machine learning model may have a similar structure as the structure of the deformation machine learning model. For instance, the compensation machine learning model structure may include minor variations relative to the structure of the deformation machine learning model to increase performance in some examples. In some examples, the compensation machine learning model and the deformation machine learning model may be graph neural networks.

To train the compensation machine learning model, the compensated model 862 may be passed to the deformation machine learning model. In some examples of generative adversarial network architectures, the discriminator and generator networks may be trained iteratively. In some examples of the techniques described herein, the deformation machine learning model may be trained alone. Then, the weights of the deformation machine learning model may be locked (e.g., frozen, static, etc.) to train the compensation machine learning model. Accordingly, the compensation machine learning model and the deformation machine learning model may not be trained in a repeated iterative fashion in some examples. Training the deformation machine learning model and then locking the weights to train the compensation machine learning model may provide stability in compensation machine learning model training.

Some examples of the techniques described herein may provide a machine learning architecture that includes two machine learning models (e.g., neural networks): a deformation machine learning model and a compensation machine learning model. The deformation machine learning model may predict geometric deformation of 3D objects and the compensation machine learning model may propose a compensation plan to offset the geometric deformation.

Some examples of the techniques described herein may utilize datasets including 3D object models, point clouds of actual printed objects, and/or point clouds of scanned objects. The datasets may be utilized to address geometric deformation and compensation of 3D object models. In some examples, a deformation machine learning model may predict deformation from a 3D object model to produce a deformed point cloud. In some examples, a compensation machine learning model may be utilized to compensate for the deformation to a 3D object model, which may reduce a disparity between the deformed point cloud and the 3D object model.

Some examples of the techniques described herein may help to increase prediction accuracy, resolution, and/or speed. For instance, some examples of the techniques described herein may provide a data-driven end-to-end machine learning architecture that may predict and compensate for geometric deformation of 3D objects that may occur during printing procedures. In some examples, during training procedures, a deformation machine learning model may guide a compensation machine learning model, such that the machine learning models may be trained in an adversarial or serial manner. Some examples of the techniques may provide flexibility to determine a training strategy based on data types and sizes. Some examples of the techniques described herein may provide a machine learning model architecture that may be scalable to address complicated geometric deformation, including geometric warpage. For instance, a machine learning model may compensate for large geometric warpage of an object.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
generating, using a compensation machine learning model after training, a compensated model based on a three-dimensional (3D) object model, wherein the compensation machine learning model is trained by generating candidate compensation plans and evaluating, using a deformation machine learning model, the candidate compensation plans; and
adjusting the 3D object model based on the compensated model to produce an adjusted model.

2. The method of claim 1, wherein the compensation machine learning model is trained while weights of the deformation machine learning model are locked.

3. The method of claim 1, further comprising converting the 3D object model to an isometric mesh.

4. The method of claim 3, wherein generating the compensated model comprises inputting the isometric mesh into the compensation machine learning model.

5. The method of claim 4, wherein the isometric mesh is represented as a 3D point cloud.

6. The method of claim 1, wherein the deformation machine learning model is trained with a loss function based on an L2 loss and a chamfer loss.

7. The method of claim 1, wherein the deformation machine learning model is trained based on a scanned object.

8. The method of claim 1, wherein the deformation machine learning model is a graph neural network.

9. The method of claim 1, further comprising printing a 3D object based on the compensated model.

10. An apparatus, comprising:
a memory;
a processor in electronic communication with the memory, wherein the processor is to:
convert a three-dimensional (3D) object model to an isometric mesh;
predicting, using a compensation machine learning model, compensation of the 3D object model based on the isometric mesh;
predicting, using a deformation machine learning model, deformation of the 3D object model based on the compensation; and
determining whether the compensation satisfies a condition based on the deformation.

11. The apparatus of claim 10, wherein the deformation is expressed as a deformed point cloud.

12. The apparatus of claim 11, wherein the compensation machine learning model is trained based on a previous training of the deformation machine learning model.

13. A non-transitory tangible computer-readable medium comprising instructions when executed cause a processor of an electronic device to:
convert a three-dimensional (3D) object model to an isometric mesh;
predict, using a first graph neural network, a compensated point cloud indicating compensation to the 3D object model based on a first graph structure of the isometric mesh;
predict, using a second graph neural network, a deformed point cloud indicating deformation to the compensated point cloud based on a second graph structure of the compensated point cloud; and
adjust the 3D object model based on the deformed point cloud to produce an adjusted 3D object model.

14. The non-transitory tangible computer-readable medium of claim 13, further comprising instructions when executed cause the processor to print the adjusted 3D object model.

15. The non-transitory tangible computer-readable medium of claim 13, further comprising instructions when executed cause the processor of the electronic device to train the second graph neural network based on an L2 loss and a chamfer loss.
